(19) United States
(12) Patent Application Publication
(10) Pub. No.: US 2022/0247573 A1
(43) Pub. Date: Aug. 4, 2022

(54) DIGITAL SIGNATURE GENERATION METHOD AND APPARATUS, COMPUTER DEVICE, AND STORAGE MEDIUM

(71) Applicant: Tencent Technology (Shenzhen) Company Limited, Shenzhen (CN)

(72) Inventors: Maocai LI, Shenzhen (CN); Zongyou WANG, Shenzhen (CN); Yifang SHI, Shenzhen (CN); Zhiyong LIAO, Shenzhen (CN); Hu LAN, Shenzhen (CN); Gengliang ZHU, Shenzhen (CN)

(21) Appl. No.: 17/722,189

(22) Filed: Apr. 15, 2022

Related U.S. Application Data
(63) Continuation of application No. PCT/CN2021/089142, filed on Apr. 23, 2021.

(30) Foreign Application Priority Data
May 26, 2020 (CN) 202010455968.9

(51) Int. Cl. H04L 9/32; H04L 9/06

(52) U.S. Cl. CPC H04L 9/3252; H04L 9/50; H04L 9/0643

(57) ABSTRACT

This application relates to a digital signature generation method and apparatus, a computer device, and a storage medium. The method includes: obtaining a message, and calculating a message hash value of the message; obtaining a signature private key, stitching the signature private key and the message hash value to obtain stitched information, calculating a hash value corresponding to the stitched information, and generating a digital signature corresponding to the message by using the hash value corresponding to the stitched information, the message hash value, and the signature private key. That is, generating a digital signature corresponding to a message by using a hash value corresponding to stitched information, a message hash value of the message, and a signature private key can improve security of the generated digital signature. This application can improve security in a blockchain consensus process.

### CROSS-REFERENCE TO RELATED APPLICATIONS

This application is a continuation application of PCT Patent Application No. PCT/CN2021/089142, entitled “DIGITAL SIGNATURE GENERATION METHOD AND APPARATUS, COMPUTER DEVICE, AND STORAGE MEDIUM” filed on Apr. 23, 2021, which claims priority to Chinese Patent Application No. 202010455968.9, filed with the State Intellectual Property Office of the People's Republic of China on May 26, 2020, and entitled “DIGITAL SIGNATURE GENERATION METHOD AND APPARATUS, COMPUTER DEVICE, AND STORAGE MEDIUM”, all of which are incorporated herein by reference in their entirety.

### FIELD OF THE TECHNOLOGY

This application relates to the field of Internet technologies, and in particular, to a digital signature generation method and apparatus, a computer device, a storage medium, and a blockchain consensus method and apparatus.

### BACKGROUND OF THE DISCLOSURE

With the development of Internet technologies, more Internet users start to pay attention to Internet security. Currently, in order to ensure security of the Internet, various encryption technologies, such as a digital signature technology, start to be used in the Internet. A digital signature (also referred to as a public key digital signature) is a digit string that can be generated only by an information sender and that cannot be forged by anyone else. This digit string is also an effective proof of the authenticity of the information sent by the information sender. A conventional state cryptography version of elliptic curve digital signature (SM2, an elliptic curve public key cryptographic algorithm released by State Cryptography Administration on Dec. 17, 2010) technology needs to rely on a secure random number generator. When the quality of a random number is not high enough, security of a digital signature is consequently reduced.

### SUMMARY

According to various embodiments provided in this application, a digital signature generation method and apparatus, a computer device, a storage medium, and a blockchain consensus method and apparatus are provided.

A for generating a digital signature for a message is performed by a computer device, and including:

obtaining a message to be signed, and calculating a message hash value of the message;

obtaining a signature private key, stitching the signature private key and the message hash value to obtain stitched information, and calculating a hash value corresponding to the stitched information; and

generating a digital signature corresponding to the message by using the hash value corresponding to the stitched information, the message hash value, and the signature private key, further including:

calculating a first part digital signature by using the hash value corresponding to the stitched information as a random number and the message hash value;

calculating a second part digital signature by using the first part digital signature, the hash value corresponding to the stitched information as the random number, and the signature private key; and

generating the digital signature corresponding to the message by using the first part digital signature and the second part digital signature.

A computer device is provided, including a memory and a processor, the memory storing computer-readable instructions, the computer-readable instructions, when executed by the processor, causing the computer device to perform the following operations:

obtaining a message to be signed, and calculating a message hash value of the message;

obtaining a signature private key, stitching the signature private key and the message hash value to obtain stitched information, and calculating a hash value corresponding to the stitched information; and

generating a digital signature corresponding to the message by using the hash value corresponding to the stitched information, the message hash value, and the signature private key, further including:

calculating a first part digital signature by using the hash value corresponding to the stitched information as a random number and the message hash value;

calculating a second part digital signature by using the first part digital signature, the hash value corresponding to the stitched information as the random number, and the signature private key; and

generating the digital signature corresponding to the message by using the first part digital signature and the second part digital signature.

One or more non-transitory storage mediums storing computer-readable instructions are provided, the computer-readable instructions, when executed by one or more processors of a computer device, causing the computer device to perform the following operations:

obtaining a message to be signed, and calculating a message hash value of the message;

obtaining a signature private key, stitching the signature private key and the message hash value to obtain stitched information, and calculating a hash value corresponding to the stitched information; and

generating a digital signature corresponding to the message by using the hash value corresponding to the stitched information, the message hash value, and the signature private key, further including:

calculating a first part digital signature by using the hash value corresponding to the stitched information as a random number and the message hash value;

calculating a second part digital signature by using the first part digital signature, the hash value corresponding to the stitched information as the random number, and the signature private key; and

generating the digital signature corresponding to the message by using the first part digital signature and the second part digital signature.

A blockchain consensus method is provided, including:

receiving a blockchain consensus request, the blockchain consensus request carrying a pending consensus block, the pending consensus block including block body information and a block hash value;

calculating an information hash value of the block body information, obtaining a shared private key, and stitching the shared private key and the information hash value to obtain a first stitching result;

calculating a hash value of the first stitching result, and generating a digital signature according to the hash value of the first stitching result, the information hash value, and the shared private key;

stitching the digital signature and the block body information to obtain a second stitching result, and calculating a hash value of the second stitching result; and

broadcasting consensus success information when the hash value of the second stitching result is consistent with the block hash value.

A computer device is provided, including a memory and a processor, the memory storing computer-readable instructions, the computer-readable instructions, when executed by the processor, causing the computer device to perform the following operations:

receiving a blockchain consensus request, the blockchain consensus request carrying a pending consensus block, the pending consensus block including block body information and a block hash value;

calculating an information hash value of the block body information, obtaining a shared private key, and stitching the shared private key and the information hash value to obtain a first stitching result;

calculating a hash value of the first stitching result, and generating a digital signature according to the hash value of the first stitching result, the information hash value, and the shared private key;

stitching the digital signature and the block body information to obtain a second stitching result, and calculating a hash value of the second stitching result; and

broadcasting consensus success information when the hash value of the second stitching result is consistent with the block hash value.

One or more non-transitory storage mediums storing computer-readable instructions are provided, the computer-readable instructions, when executed by one or more processors of a computer device, causing the computer device to perform the following operations:

receiving a blockchain consensus request, the blockchain consensus request carrying a pending consensus block, the pending consensus block including block body information and a block hash value;

calculating an information hash value of the block body information, obtaining a shared private key, and stitching the shared private key and the information hash value to obtain a first stitching result;

calculating a hash value of the first stitching result, and generating a digital signature according to the hash value of the first stitching result, the information hash value, and the shared private key;

stitching the digital signature and the block body information to obtain a second stitching result, and calculating a hash value of the second stitching result; and

broadcasting consensus success information when the hash value of the second stitching result is consistent with the block hash value.

Details of one or more embodiments of this application are provided in the accompany drawings and descriptions below. Other features, objectives, and advantages of this application become apparent from the specification, the accompanying drawings, and the claims.

### BRIEF DESCRIPTION OF THE DRAWINGS

To describe the technical solutions in embodiments of this application more clearly, the following briefly describes the accompanying drawings required for describing the embodiments. Apparently, the accompanying drawings in the following description show merely some embodiments of this application, and a person of ordinary skill in the art may still derive other accompanying drawings from these accompanying drawings without creative efforts.

FIG. 1 is an application environment diagram of a digital signature generation method according to an embodiment.

FIG. 2 is a schematic flowchart of a digital signature generation method according to an embodiment.

FIG. 3 is a schematic flowchart of determining a digital signature according to an embodiment.

FIG. 4 is a schematic flowchart of verifying a digital signature according to an embodiment.

FIG. 5 is a schematic flowchart of calculating a target first part digital signature according to an embodiment.

FIG. 6 is a schematic flowchart of a digital signature generation method according to a specific embodiment.

FIG. 7 is an application environment diagram of a blockchain consensus method according to an embodiment.

FIG. 8 is a schematic flowchart of a blockchain consensus method according to an embodiment.

FIG. 9 is a schematic diagram of a block structure of a pending consensus block according to an embodiment.

FIG. 10 is a schematic flowchart of verifying a written digital signature according to an embodiment.

FIG. 11 is a schematic flowchart of a shared key according to an embodiment.

FIG. 12 is a structural block diagram of a digital signature generation apparatus according to an embodiment.

FIG. 13 is a structural block diagram of a blockchain consensus apparatus according to an embodiment.

FIG. 14 is a diagram of an internal structure of a computer device according to an embodiment.

FIG. 15 is a diagram of an internal structure of a computer device according to another embodiment.

### DESCRIPTION OF EMBODIMENTS

To make the objectives, technical solutions, and advantages of this application clearer and more understandable, this application is further described in detail below with reference to the accompanying drawings and the embodiments. It is to be understood that the specific embodiments described herein are only used for explaining this application, and are not used for limiting this application.

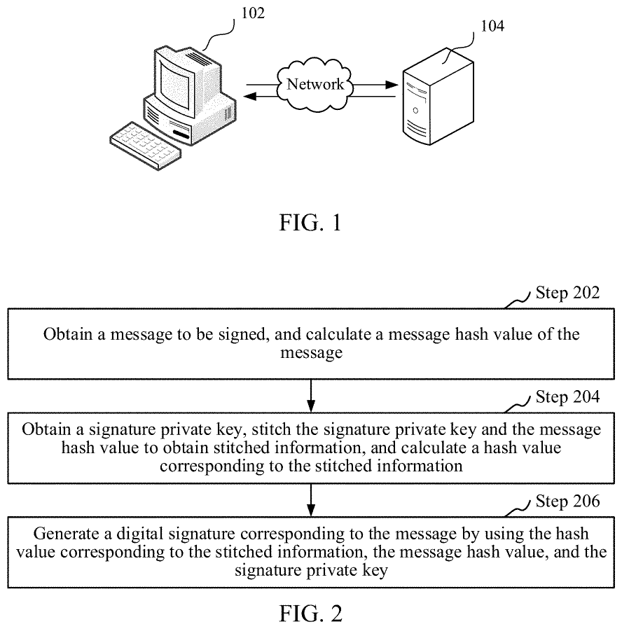

A digital signature generation method provided in this application may be applied to an application environment shown in FIG. 1. A terminal 102 communicates with a server 104 through a network. The terminal 102 obtains a message, and calculates a message hash value of the message. The terminal 102 obtains a signature private key, stitches the signature private key and the message hash value to obtain stitched information, and calculates a hash value corresponding to the stitched information. The terminal 102 generates a digital signature corresponding to the message by using the hash value corresponding to the stitched information, the message hash value, and the signature private key. The terminal 102 may store the generated digital signature and the message in memory, or the terminal may send the generated digital signature and the message the server 104. The server 104 may send the received digital signature and the message to a receiver terminal. The terminal 102 may be, but not limited to, a personal computer, a notebook computer, a smartphone, a tablet computer, and a portable wearable device. The server 104 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform.

In an embodiment, as shown in FIG. 2, a digital signature generation method is provided. That the method is applied to the terminal in FIG. 1 is used as an example for description. It can be understood that, the method may also be applied to a server, or may also be applied to a system including a terminal and a server and is implemented through the interaction between the terminal and the server. In this embodiment, the following steps are included:

Step 202. Obtain a message, and calculate a message hash value of the message.

The message refers to a message that needs to be digitally signed. The message is data that needs to be sent to a receiver terminal, such as, various files, documents, digital ledgers, and emails. The message hash value is obtained by compressing the message into a digest, and can reduce an amount of data in the message.

Specifically, the terminal obtains the message, and then may calculate a message hash value of the message by using a hash algorithm. The hash algorithm transforms an input of any length (also referred to as a pre-map pre-image) into an output of a fixed length through a hash algorithm, and the output is a hash value. The hash algorithm includes, but is not limited to, a message digest 4 (MD4) algorithm, an SM3 algorithm (a standard for cryptographic hash functions), a message digest 5 (MD5) algorithm, a secure hash algorithm (SHA), and the like.

In an embodiment, a user identifier corresponding to the terminal may be obtained. The user identifier and the message are stitched, and a stitched message hash value is calculated.

Step 204. Obtain a signature private key, stitch the signature private key and the message hash value to obtain stitched information, and calculate a hash value corresponding to the stitched information.

The signature private key is a private key in a key pair obtained according to an asymmetric encryption algorithm. The asymmetric encryption algorithm includes, but is not limited to, an RSA algorithm, a digital signature algorithm (DSA) algorithm, and an Elliptic Curve Digital Signature Algorithm (ECDSA). Stitching refers to concatenating two parts of data into one part of data, for example, concatenating two parts of data of the signature private key and the message hash value into one part of data. The signature private key may be stitched before the message hash value, or the signature private key may be stitched after the message hash value. The stitched information is data obtained by stitching the signature private key and the message hash value.

Specifically, the terminal obtains a private key. The private key may be confidentially prestored in the terminal, and then obtained after decryption by a user, or may be input by a user through the terminal, or may be provided by a third party. The third party refers to a third-party platform used for providing a private key. When the private key is obtained, the signature private key and the message hash value are stitched to obtain stitched information, and then a hash value corresponding to the stitched information is calculated by using a hash algorithm. For example, an obtained signature private key is “ABC12”, an obtained message hash value is “567dfghh”, and obtained stitched information is “ABC12567dfghh”. Then a hash value of the stitched information “ABC12567dfghh” is calculated by using SHA.

In an embodiment, step 204 of obtaining a signature private key, and stitching the signature private key and the message hash value to obtain stitched information includes the following step:

obtaining the signature private key, converting the signature private key into target information according to a preset conversion rule, and stitching the target information and the message hash value to obtain the stitched information.

The preset conversion rule refers to a preset rule for converting the signature private key. The target information refers to information obtained after the signature private key is converted according to the preset conversion rule. The target information is non-public information.

Specifically, the terminal obtains the signature private key, converts the signature private key into the target information according to the preset conversion rule, and then stitches the target information and the message hash value to obtain the stitched information.

In the embodiment, the signature private key is converted into the target information according to the preset conversion rule, and the target information and the message hash value are stitched to obtain the stitched information, so that the risk of leakage of the signature private key is reduced, thereby improving the security of the signature private key.

In an embodiment, the converting the signature private key into target information according to a preset conversion rule includes the following step:

converting the signature private key into a bit string to obtain a bit string private key, and arranging the bit string private key in reverse order to obtain the target information.

A bit refers to a unit of information content and is the smallest unit of data storage within a computer. The bit string private key refers to private key information that is converted into binary storage after the signature private key is encoded according to ANSI. Arrangement in reverse order refers to re-arranging the bit string private key in an opposite order.

Specifically, the terminal may convert the signature private key into a bit string to obtain a bit string private key, and arrange the bit string private key in reverse order to obtain the target information. For example, the signature private key is “9”, a bit string private key obtained through conversion is “00111001”, “00111001” is arranged in reverse order, and obtained target information is “10011100”.

Alternatively, the signature private key may be converted into a byte string through encoding to obtain a byte string private key. The byte string private key is arranged in reverse order to obtain the target information. A byte refers to a unit of measurement used by a computer information technology to measure a storage capacity, is a binary digit string processed as a unit, and is a small unit for constituting information. The most commonly used byte is an eight-bit byte, that is, the byte includes eight bits of binary numbers, such as, a byte string private key obtained by encoding the signature private key by using the American Standard Code for Information Interchange (ASCII).

In this embodiment, the signature private key is converted into a bit string, and the bit string private key is arranged in reverse order to obtain target information, making the obtained target information more secure.

In an embodiment, the converting the signature private key into target information according to a preset conversion rule includes the following step:

obtaining a preset mapping relationship, obtaining conversion information corresponding to the signature private key according to the preset mapping relationship, and using the conversion information as the target information.

The preset mapping relationship is used for reflecting a mapping relationship between the signature private key and the target information, and is obtained by associating the signature private key and the target information in advance. The conversion information refers to information corresponding to the signature private key obtained according to the mapping relationship.

Specifically, the terminal obtains the preset mapping relationship, and finds the conversion information corresponding to the signature private key according to the preset mapping relationship.

In this embodiment, the conversion information corresponding to the signature private key is obtained according to the preset mapping relationship, the conversion information is used as the target information, and then the target information is used for subsequent processing, thereby reducing the security risk of the signature private key and increasing the difficulty of cracking.

Step 206. Generate a digital signature corresponding to the message by using the hash value corresponding to the stitched information, the message hash value, and the signature private key.

Specifically, the terminal calculates the first part digital signature by using the hash value corresponding to the stitched information and the message hash value, calculates the second part digital signature by using the first part digital signature, the hash value corresponding to the stitched information, and the signature private key, obtains the digital signature corresponding to the message according to the first part digital signature and the second part digital signature, and then may send the digital signature and the message together to the receiver terminal. The receiver terminal receives the digital signature and the message, verifies the digital signature. When the verification succeeds, it indicates that the obtained message has not been tampered with and is sent by the sender.

According to the digital signature generation method and apparatus, the computer device, and the storage medium described above, a message hash value of a message is calculated by obtaining the message. A signature private key is obtained, the signature private key and the message hash value are stitched to obtain stitched information, a hash value corresponding to the stitched information is calculated, and a digital signature corresponding to the message is generated by using the hash value corresponding to the stitched information, the message hash value, and the signature private key. That is, the digital signature is generated by using the hash value corresponding to the stitched information as a random number, thereby avoiding generation of a low-quality random number, and improving security of the generated digital signature. In addition, because the hash value corresponding to the stitched information is used as a random number, the same private key and the same message generate the same digital signature. This can be applied in a scenario in which the same message is digitally signed by using the same private key to obtain the same signature result, for example, for duplicate signature detection, thereby expanding application scenarios.

In an embodiment, as shown in FIG. 3, step 206 of generating a digital signature corresponding to the message by using the hash value corresponding to the stitched information, the message hash value, and the signature private key includes the following steps:

Step 302. Obtain an elliptic curve base point, and perform calculation by using the hash value corresponding to the stitched information and the elliptic curve base point to obtain elliptic curve point coordinates.

The elliptic curve base point is coordinates of a base point on an elliptic curve, with an order being a prime number. The elliptic curve is pre-selected, and may be selected by using a complex multiplication or random selection method. The elliptic curve point coordinates are used for calculating the digital signature, and are obtained through calculation by using the hash value corresponding to the stitched information and the elliptic curve base point.

Specifically, the terminal obtains the elliptic curve base point, and calculates a product of the elliptic curve base point and the hash value corresponding to the stitched information to obtain elliptic curve point coordinates. For example, the hash value corresponding to the stitched information may be converted into a positive integer, and a sum of the positive integer quantity of elliptic curve base points is calculated to obtain the elliptic curve point coordinates.

Step 304. Determine corresponding order information according to the elliptic curve base point, and perform calculation by using the message hash value, the elliptic curve point coordinates, and the order information to obtain a first part digital signature.

The order information is a value of an order corresponding to the elliptic curve base point, and the value is a prime number. The first part digital signature is a first part value in the digital signature. The first part value is obtained through calculation according to the message hash value, the elliptic curve point coordinates, and the order information.

Specifically, the terminal determines the corresponding order information according to the elliptic curve base point, calculates a sum of the message hash value and a horizontal coordinate in the elliptic curve point coordinates, calculates a sum of the message hash value and a horizontal coordinate in the elliptic curve point coordinates and performs a modulo operation on the sum and the order information, to obtain an operation result, and uses the operation result as the first part digital signature.

Step 306. Perform calculation by using the first part digital signature, the hash value corresponding to the stitched information, the signature private key, and the order information calculation to obtain a second part digital signature when the first part digital signature meets a preset first condition.

The preset first condition is a preset condition that the first part digital signature is calculated correctly, and may be that the first part digital signature is not zero or that the first part digital signature is not the hash value corresponding to the stitched information. The second part digital signature is a second part value in the digital signature. The second part value is obtained through calculation according to the first part digital signature, the hash value corresponding to the stitched information, the signature private key, and the order information.

Specifically, the terminal determines whether the first part digital signature meets the preset first condition, when the preset first condition is not met, it indicates that the first part digital signature is calculated incorrectly, and recalculation is required. In this case, go back to the step of stitching the signature private key and the message hash value to obtain stitched information. A preset rule for processing when the signature is incorrect is obtained, the stitched information is processed to obtain processed stitched information, then a hash value corresponding to the processed stitched information is calculated by using the processed stitched information, and calculation is performed by using the hash value of the processed stitched information to obtain the first part digital signature. Then, it is determined whether the first part digital signature meets the preset first condition. The preset rule for processing when the signature is incorrect may be obtaining a preset special symbol, such as “$”, “#”, “@”, and “&”, and stitching the special symbol and the stitched information again to obtain the processed stitched information. The preset rule for processing when the signature is incorrect is obtained may alternatively be arranging the signature private key and the stitched information of the message hash value in reverse order to obtain processed stitched information, and so on.

When the preset first condition is met, the second part digital signature is directly calculated by using the first part digital signature, the hash value corresponding to the stitched information, the signature private key, and the order information.

Step 308. Determine the digital signature according to the first part digital signature and the second part digital signature when the second part digital signature meets a preset second condition.

The preset second condition is a preset condition that the second part digital signature is calculated correctly, and may be that the second part digital signature is not zero.

Specifically, the terminal determines whether the second part digital signature obtained through calculation meets the preset second condition. When the preset second condition is not met, go back to stitching the signature private key and the message hash value to obtain stitched information. A preset rule for processing when the signature is incorrect is obtained, processed stitched information is obtained, then a hash value corresponding to the processed stitched information is calculated by using the processed stitched information, and calculation is performed by using the hash value of the processed stitched information to obtain the second part digital signature. Then, it is determined whether the second part digital signature meets the preset second condition. The preset rule for processing when the signature is incorrect may be obtaining a preset special symbol, such as “$”, “#”, “@”, or “&”, and stitching the special symbol, the signature private key, and the message hash value together, to obtain processed stitched information. The preset rule for processing when the signature is incorrect is obtained may alternatively be arranging the signature private key and the stitched information of the message hash value in reverse order to obtain processed stitched information, and so on.

When the preset second condition is met, the digital signature corresponding to the message is determined according to the first part digital signature and the second part digital signature.

In the foregoing embodiment, the elliptic curve point coordinates are obtained through calculation by using the elliptic curve base point, and the first part digital signature is calculated by using the message hash value, the elliptic curve point coordinates, and the order information. Then, the second part digital signature may be calculated by using the first part digital signature, the hash value corresponding to the stitched information, the signature private key, and the order information. Finally, the digital signature corresponding to the message is determined according to the first part digital signature and the second part digital signature. In this way, the security of the obtained digital signature is improved.

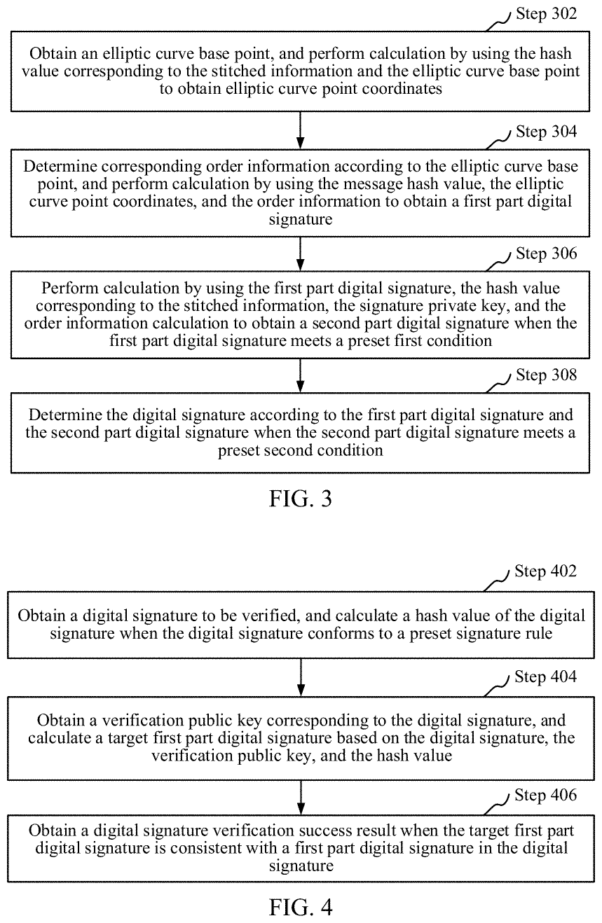

In an embodiment, as shown in FIG. 4, the method further includes:

Step 402. Obtain a digital signature, and calculate a hash value of the digital signature when the digital signature conforms to a preset signature rule.

The digital signature is a digital signature that corresponds to the message obtained by the terminal and that needs to be verified. The preset signature rule is a preset rule for verifying the digital signature. The preset signature rule may be that the digital signature falls within a preset value range. For example, a value of the order information (n) of the elliptic curve base point minus one is calculated to obtain a maximum value, and 1 is used as a minimum value, to obtain a preset value range [1, n−1].

Specifically, the terminal may obtain a message sent by a sender terminal and a digital signature corresponding to the message, use the digital signature as the digital signature, and determine whether a first part digital signature in the digital signature conforms to a preset signature rule. When the first part digital signature in the digital signature does not conform to the preset signature rule, the digital signature is not successfully verified, and the obtained message may be tempered with. When the first part digital signature in the digital signature conforms to the preset signature rule, it is determined whether a second part digital signature in the digital signature conforms to the preset signature rule. When the second part digital signature in the digital signature does not conform to the preset signature rule, the digital signature is not successfully verified, and the obtained message may be tempered with. When the second part digital signature in the digital signature conforms to the preset signature rule, a hash value of the digital signature is calculated by using a hash value algorithm. In an embodiment, a user identifier of a sender may be obtained. The digital signature and the user identifier of the sender are stitched. A hash value after the stitching is calculated by using a hash value algorithm. In an embodiment, the digital signature may alternatively be a digital signature corresponding to the message.

Step 404. Obtain a verification public key corresponding to the digital signature, and calculate a target first part digital signature based on the digital signature, the verification public key, and the hash value.

The verification public key is a public key corresponding to a signature private key used during generation of the digital signature, and is used for verifying the digital signature. The target first part digital signature is a first part digital signature obtained through calculation by the terminal by using the verification public key.

Specifically, the terminal may obtain the verification public key in advance and stores the verification public key. When digital signature verification is required, the terminal obtains the verification public key corresponding to the digital signature, and calculates the target first part digital signature based on the digital signature, the verification public key, and the hash value.

Step 406. Obtain a digital signature verification success result when the target first part digital signature is consistent with a first part digital signature in the digital signature.

Specifically, the terminal determines whether the target first part digital signature is consistent with the first part digital signature in the digital signature. A digital signature verification success result is obtained when the target first part digital signature is consistent with the first part digital signature in the digital signature. A digital signature verification failure result is obtained when the target first part digital signature is inconsistent with the first part digital signature in the digital signature.

In the foregoing embodiment, the target first part digital signature is calculated by using the digital signature, the verification public key, and the hash value, and it is determined whether the target first part digital signature is consistent with the first part digital signature in the digital signature, so that a verification result corresponding to the digital signature can be obtained.

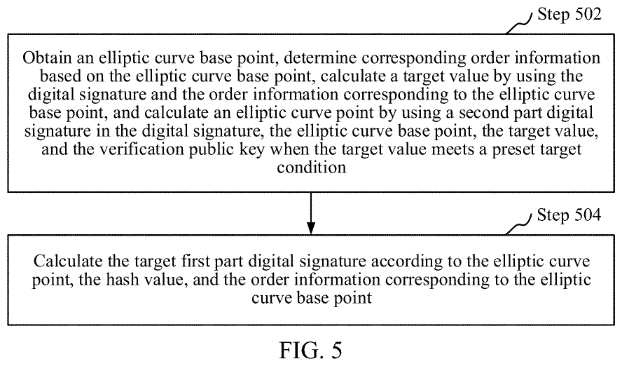

In an embodiment, as shown in FIG. 5, step 404 of obtaining a verification public key corresponding to the digital signature, and calculating a target first part digital signature based on the digital signature, the verification public key, and the hash value includes the following steps:

Step 502. Obtain an elliptic curve base point, determine corresponding order information based on the elliptic curve base point, calculate a target value by using the digital signature and the order information corresponding to the elliptic curve base point, and calculate a to-be-verified elliptic curve point by using a second part digital signature in the digital signature, the elliptic curve base point, the target value, and the verification public key when the target value meets a preset target condition.

The target value is a value obtained after a modulo operation is performed on the digital signature. The preset target condition is a preset condition that the target value is calculated correctly, and may be that the target value is not zero.

Specifically, the terminal obtains the elliptic curve base point, then calculates the order information corresponding to the elliptic curve base point, calculates a sum of the first part digital signature and the second part digital signature in the digital signature, then performs a modulo operation on the sum of the first part digital signature and the second part digital signature in the digital signature and the order information of the elliptic curve base point to obtain a modulo result, and uses the modulo result as the target value. Then, it is determined whether the target value meets the preset target condition. When the preset target condition is not met, a digital signature verification failure result is obtained. When the preset target condition is met, the terminal calculates a product of the second part digital signature in the digital signature and the elliptic curve base point, calculates a product of the target value and the verification public key, and then calculates a sum of the two products to obtain the to-be-verified elliptic curve point.

Step 504. Calculate the target first part digital signature according to the to-be-verified elliptic curve point, the hash value, and the order information corresponding to the elliptic curve base point.

The target first part digital signature is a first part digital signature obtained through calculation according to a received to-be-verified message.

Specifically, the terminal calculates a sum of the hash value and a horizontal coordinate in the to-be-verified elliptic curve point, then obtains the order information of the elliptic curve base point, performs a modulo operation on the sum and the order information, that is, an operation of dividing the sum by the order information, to obtain a modulo result, and uses the modulo result as the target first part digital signature.

In the foregoing embodiment, verification of the digital signature can ensure that a message corresponding to a to-be-verified signature received by the terminal is not tempered with.

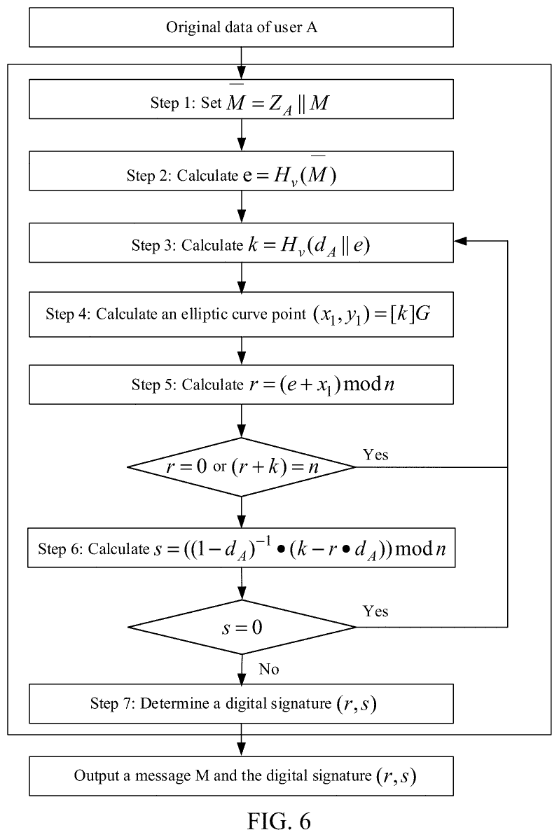

In a specific embodiment, a user terminal A stores original data, that is, a user identifier Z_{A} of a system parameter of an elliptic curve s, a message M, a verification public key p_{A}, and a signature private key d_{A}. As shown in FIG. 6, a digital signature generation method includes the following steps:

Step 1: Set M̅=Z_{A}∥M, that is, stitch the user identifier Z_{A} and the message M to obtain a stitching result M̅.

Step 2: Calculate e=H_{ν}(M̅), that is, calculate a message hash value e of the stitching result M̅ by using a hash algorithm, where H_{ν}( ) is a hash algorithm with a message digest length of v bits.

Step 3: Calculate k=H_{ν}(d_{A}∥e), that is, stitch the signature private key d_{A} and the message hash value e, and then calculate a value k of a stitching result by using the hash algorithm.

Step 4: Calculate an elliptic curve point (x₁, y₁)=[k]G, where [k]G is a k-fold point on the elliptic curve at point G. That is, obtain an elliptic curve base point G, and calculate a sum of k elliptic curve base points G, to obtain an elliptic curve point (x₁, y₁).

Step 5: Calculate r=(e+x₁) mod n, that is, calculate a sum of the message hash value e and a horizontal coordinate x₁ in the elliptic curve point, obtain a corresponding order n according to the elliptic curve base point G, and perform a modular order n operation on the sum of the message hash value e and the horizontal coordinate x₁ in the elliptic curve point, to obtain an operation result as a first part digital signature r. In this case, determine whether r is zero, that is, whether r=0, or whether a sum of the first part digital signature r and k is equal to the order n, that is, whether (r+k)=n. When r=0 or (r+k)=n, return step 3 to re-calculate k, and when r is not equal to zero and the sum of the first part digital signature r and k is not equal to the order n, perform step 6.

Step 6: Calculate s=((1−d_{A})⁻¹·(k−r·d_{A}))mod n, that is, calculate a first value obtained by subtracting the signature private key d_{A} from one, and calculate a second value obtained by subtracting a product of the first part digital signature r and the signature private key d_{A} from k. Calculate a product of an inverse element of the first value and a modular order n of the second value, to obtain an operation result as a second part digital signature s.

Step 7: Determine a digital signature (r, s).

Then, output the digital signature (r, s) and the message M.

In this embodiment, the signature private key d_{A} and the message hash value e are stitched, then the value k of the stitching result is calculated by using the hash algorithm, and then calculation is performed by using the value k to obtain the digital signature, so that reliance on a secure random number generator is removed, thereby improving security of a digital signature generated by using an SM2 algorithm.

In addition, the same digital signature (r, s) is made to be obtained through calculation by using the same message and the same private key. Because the private key is not public, the obtained k is also not public, and because different messages have different message hash values e, the different messages generate different values of k, and different private keys generate different values of k. Therefore, it can be ensured that the same digital signature is obtained through calculation by using the same message and the same private key while security of the digital signature is ensured. That is, this can be applied to a scenario that requires the same result of signing the same message by the same private key, thereby broadening an application scenario. For example, in a scenario of detecting duplication of the digital signature, when the same message is digitally signed by using the same private key for a plurality of times to obtain a plurality of digital signatures, if signature results are consistent, it indicates that the digital signatures are duplicated. This helps check the duplication of the digital signature, and avoids difficulty in detecting the duplication.

In an embodiment, after step 206 of generating a digital signature corresponding to the message by using the hash value corresponding to the stitched information, the message hash value, and the signature private key, the digital signature and the message may be stitched, a stitched hash value of a stitching result may be calculated, and the message and the stitched hash value may be sent to the sender terminal. After receiving the message and the stitched hash value, the sender terminal calculates a message hash value of the message, obtains the signature private key, and stitches the signature private key and the message hash value of the message; calculates a hash value of the stitching result, and generates a digital signature according to the hash value of the stitching result, the message hash value, and a shared private key; stitches the digital signature and the message to obtain a stitching result, and calculates a hash value of the stitching result; and when the hash value is consistent with the stitched hash value, the digital signature is successfully verified, further improving the security of the digital signature.

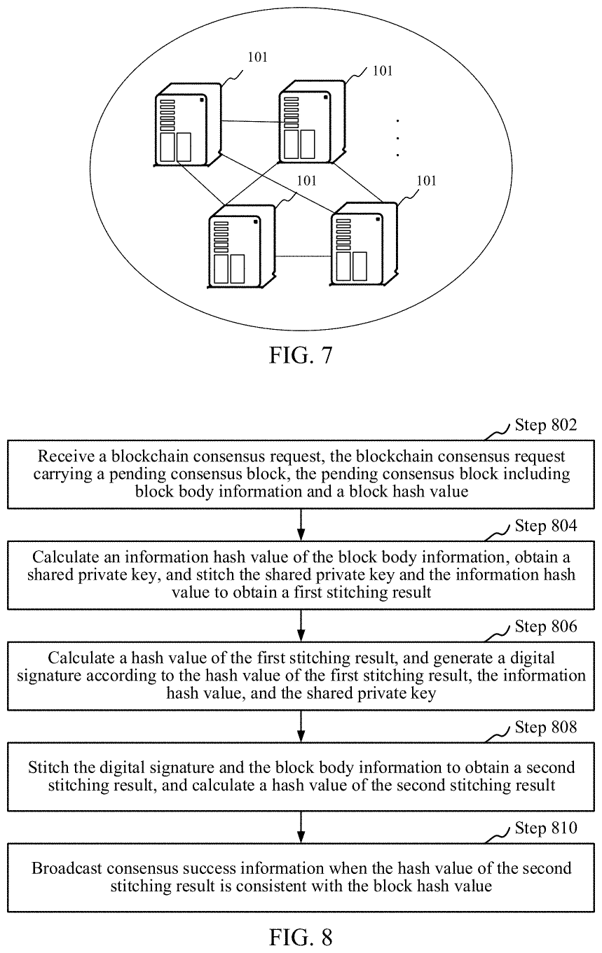

A blockchain consensus method provided in this application may be applied to an application environment shown in FIG. 7. The application environment includes each blockchain node 101. The blockchain node 101 receives a blockchain consensus request, the blockchain consensus request carrying a pending consensus block, the pending consensus block including block body information and a block hash value; calculates an information hash value of the block body information, obtains a shared private key, and stitches the shared private key and the information hash value to obtain a first stitching result; and calculates a hash value of the first stitching result, and generates a digital signature according to the hash value of the first stitching result, the information hash value, and the shared private key. The blockchain node 101 stitches the digital signature and the block body information to obtain a second stitching result, and calculates a hash value of the second stitching result. The blockchain node 101 broadcasts consensus success information to other blockchain nodes when the hash value of the second stitching result is consistent with the block hash value. The blockchain node may be any form of computing device connected to a blockchain, such as a server or a user terminal.

In an embodiment, as shown in FIG. 8, a blockchain consensus method is provided. That the method is applied to the blockchain node in FIG. 7 is used as an example for description. The following steps are included:

S802. Receive a blockchain consensus request, the blockchain consensus request carrying a pending consensus block, the pending consensus block including block body information and a block hash value.

The blockchain is a new application mode of computer technologies such as distributed data storage, point-to-point transmission, a consensus mechanism, and an encryption algorithm. The blockchain is essentially a decentralized database and a series of associated data blocks generated in a cryptographic manner. Each data block includes information about a batch of network transactions for verifying the validity of the information (for anti-counterfeiting) and generating a next block. The blockchain may include a public blockchain, a consortium blockchain, and a private blockchain. The pending consensus block is a newly generated block in the blockchain, requires consensus, and can be written into the blockchain after the consensus is reached. FIG. 9 is an exemplary schematic diagram of a block structure of a pending consensus block. The pending consensus block includes block body information, a block hash value, and a hash value of a previous block. Blocks are linked by hash values to form a blockchain. In addition, the block may further include information such as a timestamp indicating a block generation time. The block body information refers to information stored in a block body of the pending consensus block. The information is data that can be written into the blockchain. The data may be text, images, videos, and the like. For example, the data may be transaction data, ledger data, smart contract data, or the like. The block hash value is a hash value obtained through calculation by using the block body information and a digital signature corresponding to the block body information. The digital signature corresponding to the block body information is generated by using the digital signature generation method in the foregoing embodiment.

Specifically, each blockchain node receives a blockchain consensus request. The blockchain consensus request may be sent by a master node in the blockchain. The blockchain consensus request carries a pending consensus block. The pending consensus block includes block body information and a block hash value.

S804. Calculate an information hash value of the block body information, obtain a shared private key, and stitch the shared private key and the information hash value to obtain a first stitching result.

The shared private key is a private key owned by all blockchain nodes in the blockchain that have consensus voting rights. The shared private key is a private key in a key pair generated according to an asymmetric encryption algorithm and is pre-shared to each blockchain node with a consensus voting right. The blockchain node with the consensus voting right stores the shared private key. The first stitching result refers to a stitching result of the shared private key and the information hash value.

Specifically, when the blockchain node does not store any shared private key, the blockchain node has no right for consensus. When the blockchain node stores a shared private key, an information hash value of the block body information is calculated, a shared private key is obtained, and the shared private key and the information hash value are stitched, to obtain a first stitching result.

S806. Calculate a hash value of the first stitching result, and generate a digital signature according to the hash value of the first stitching result, the information hash value, and the shared private key.

Specifically, the blockchain node calculates a hash value of the first stitching result, and generates a digital signature according to the hash value of the first stitching result, the information hash value, and the shared private key. In an embodiment, an elliptic curve base point may be obtained, and calculation is performed by using the hash value of the first stitching result and the elliptic curve base point to obtain elliptic curve point coordinates; corresponding order is determined according to an elliptic curve base point, calculation is performed by using the information hash value of the block body information, the elliptic curve point coordinates, and the order of the elliptic curve base point to obtain a first part digital signature, and when the first part digital signature meets a preset first condition, calculation is performed by using the first part digital signature, the hash value of the first stitching result, the shared private key, and the order of the elliptic curve base point to obtain a second part digital signature; and when the second part digital signature meets a preset second condition, a digital signature is determined according to the first part digital signature and the second part digital signature.

S808. Stitch the digital signature and the block body information to obtain a second stitching result, and calculate a hash value of the second stitching result.

S810. Broadcast consensus success information when the hash value of the second stitching result is consistent with the block hash value.

The second stitching result is obtained by concatenating the block body information and the digital signature corresponding to the block body information. The consensus success information is used for representing that consensus verification of the blockchain node succeeds.

Specifically, the blockchain node broadcasts consensus success information to the blockchain when determining that the hash value of the second stitching result is consistent with the block hash value.

In the foregoing blockchain consensus method, when the blockchain node receives the pending consensus block, the digital signature of the block body information in the pending consensus block is calculated, and then the digital signature and the block body information are stitched, so that the hash value of the stitching result can be calculated. The hash value of the stitching result is compared with a block body hash value in the pending consensus block, and when the hash values are consistent, consensus verification succeeds, allowing each blockchain node to use the shared private key to generate the same digital signature. Then each blockchain node performs calculation by using the digital signature and the block body information to obtain the hash value. This ensures that when the block body information is complete and correct, the hash value obtained through calculation by each blockchain node having a shared private key is consistent with a received block hash value, so that consensus success can be ensured, thereby improving security of blockchain consensus.

In an embodiment, after step 810 of broadcasting consensus success information when the hash value of the second stitching result is consistent with the block hash value, the method includes the following step:

writing the pending consensus block and the digital signature into a blockchain when consensus is complete.

Specifically, that the consensus is complete means when consensus verification of more than a preset quantity of blockchain nodes with a shared private key succeeds. For example, consensus verification of more than 51% of the blockchain nodes with the shared private key succeeds. In this case, the blockchain node writes the pending consensus block and the digital signature of the block body information in the pending consensus block into the blockchain together. This can cause different blockchain nodes to use the shared private key to generate the digital signature of the same pending consensus block and calculate the hash value corresponding to the stitching result of the digital signature of the same pending consensus block and the block body information, and compare the foregoing hash value with the received block hash value, so that blockchain nodes with a shared private key can complete consensus, thereby improving blockchain consensus security.

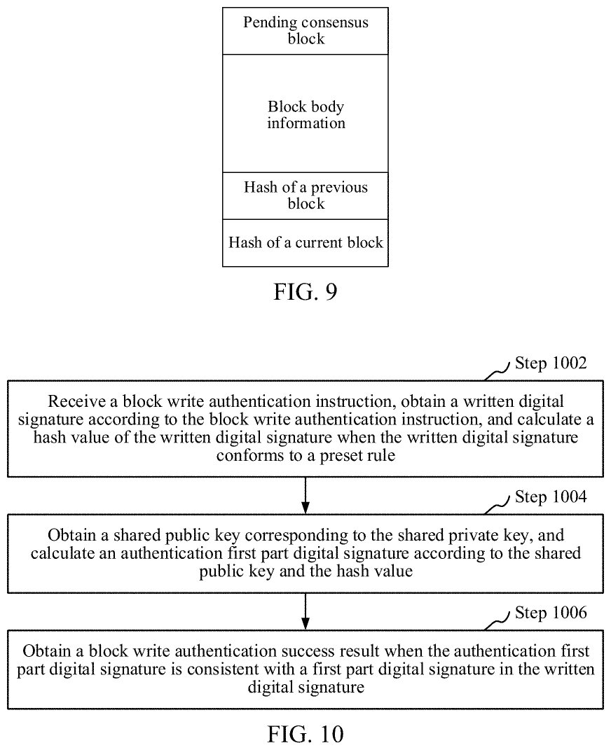

In an embodiment, as shown in FIG. 10, after the writing the pending consensus block and the digital signature into a blockchain when consensus is complete, the method further includes the following steps:

Step 1002. Receive a block write authentication instruction, obtain a written digital signature according to the block write authentication instruction, and calculate a hash value of the written digital signature when the written digital signature conforms to a preset rule.

Block write authentication refers to verifying whether a digital signature written into a block is consistent with a digital signature calculated by using a shared private key, and is used for indicating that it is a digital signature written by a blockchain node with a shared private key. The written digital signature is a digital signature already stored in the blockchain. The preset rule is a preset rule for checking whether a digital signature is valid. The preset rule may be that the written digital signature falls within a preset value range. For example, a value of the order information (n) of the elliptic curve base point minus one is calculated to obtain a maximum value, and 1 is used as a minimum value, to obtain a preset value range [1, n−1].

Specifically, the blockchain node receives the block write authentication instruction, obtains the written digital signature from the blockchain according to the block write authentication instruction, and determines whether the written digital signature conforms to the preset rule. When the written digital signature does not conform to the preset rule, it is obtained that the written digital signature is unsuccessfully verified. This indicates that the digital signature is not written by a blockchain node with a shared private key. When the written digital signature conforms to the preset rule, a hash value of the written digital signature is calculated by using a hash algorithm.

Step 1004. Obtain a shared public key corresponding to the shared private key, and calculate an authentication first part digital signature according to the shared public key and the hash value.

The shared public key and the shared private key are a key pair generated by using an asymmetric encryption algorithm. The authentication first part digital signature is a first part digital signature obtained through calculation by using the shared public key and the hash value, and is used for comparison with a first part digital signature in the written digital signature.

Specifically, the blockchain node obtains the shared public key corresponding to the shared private key, and calculates the authentication first part digital signature according to the shared public key and the hash value. The shared public key may be obtained through calculation by using a shared private key, such as a shared private key generated by using an elliptic curve encryption algorithm. Calculation may be performed by using the elliptic curve base point and the shared private key to obtain the shared public key. In an embodiment, the elliptic curve base point is obtained, the target value is calculated by using the written digital signature and the order information corresponding to the elliptic curve base point, when the target value meets the preset target condition, the to-be-verified elliptic curve point is calculated by using the second part digital signature in the written digital signature, the elliptic curve base point, the target value, and the shared public key, and the authentication first part digital signature is calculated according to the to-be-verified elliptic curve point, the hash value, and the elliptic curve base point.

Step 1006. Obtain a block write authentication success result when the authentication first part digital signature is consistent with a first part digital signature in the written digital signature.

Specifically, the blockchain node determines whether the authentication first part digital signature is consistent with the first part digital signature in the written digital signature. When the authentication first part digital signature is inconsistent with the first part digital signature in the written digital signature, an authentication failure result is obtained, and when the authentication first part digital signature is consistent with the first part digital signature in the written digital signature, an authentication success result is obtained.

In the foregoing embodiment, the blockchain node may verify a digital signature written into the blockchain. When the verification succeeds, it indicates that the digital signature is a digital signature written by a blockchain node with a shared private key, thereby facilitating subsequent verification by a user.

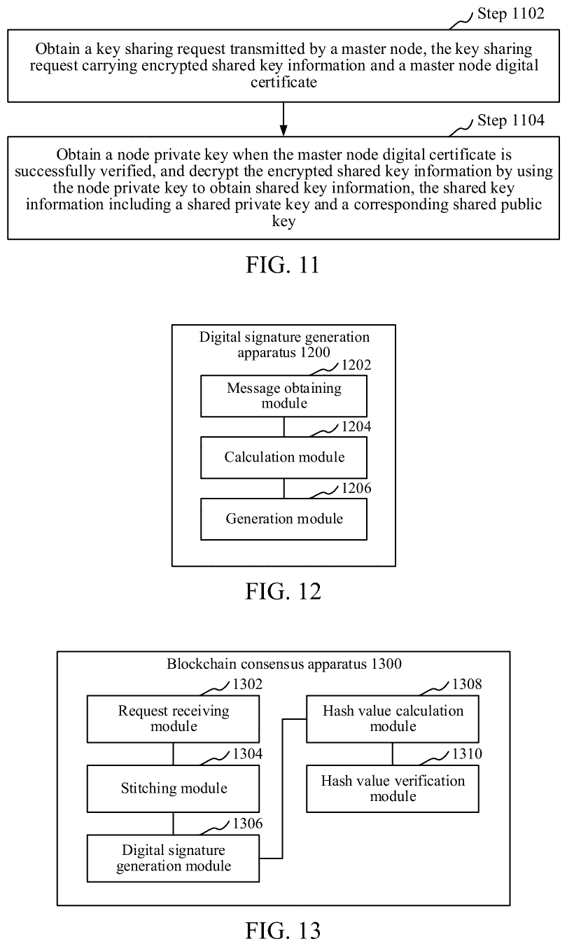

In an embodiment, as shown in FIG. 11, before step 802 of receiving a blockchain consensus request, the blockchain consensus request carrying a pending consensus block, the pending consensus block including block body information and a block hash value, the method further includes the following steps:

Step 1102. Obtain a key sharing request transmitted by a master node, the key sharing request carrying encrypted shared key information and a master node digital certificate.

The master node is an encrypted and complete node in the blockchain, and supports a blockchain network by storing a copy of the entire blockchain. The shared key information is a shared key pair for digital signature, including a shared private key and a shared public key. The digital certificate refers to a digital authentication that marks identity information of communication parties in Internet communication, and people may use the digital certificate to identify an identity of the other part on the Internet. The master node digital certificate is used for verifying whether the encrypted shared key information is sent by the master node.

Specifically, to join the blockchain, the blockchain node needs to obtain the shared private key from the master node. In this case, the blockchain node may obtain the key sharing request sent by the master node. The key sharing request carries the encrypted shared key information and the master node digital certificate.

Step 1104. Obtain a node private key when the master node digital certificate is successfully verified, and decrypt the encrypted shared key information by using the node private key to obtain shared key information, the shared key information including a shared private key and a corresponding shared public key.

The node private key is a private key in a key pair assigned by the blockchain node when the blockchain node joints the blockchain. The node private key is different from the shared private key and is unique to the blockchain node. Each blockchain node has a corresponding node private key.

Specifically, the blockchain node obtains a stored node private key when the master node digital certificate is successfully verified, decrypts the encrypted shared key information by using the node private key to obtain shared key information, and then stores the shared key information. The shared key information includes a shared private key and a corresponding shared public key. In an embodiment, the encrypted shared key information may be directly stored when the master node digital certificate is successfully verified. When the shared private key or the shared public key needs to be used, the encrypted shared key information is decrypted by using the node private key, to obtain the shared private key or the shared public key.

In the foregoing embodiment, the master node sends the shared private key to an authorized blockchain node, so that the authorized blockchain node stores the shared private key. This can ensure that a blockchain node authorized by the master node has the shared private key, so that the authorized blockchain node can perform blockchain consensus verification, thereby improving blockchain security.

This application further provides an application scenario. The foregoing blockchain consensus method is applied to the application scenario. Specifically, the application of the blockchain consensus method in the application scenario is as follows:

In an electronic invoice consortium blockchain, a master node assigns a shared private key to an authorized blockchain node, and the blockchain node stores the shared private key.

When a new block needs to be written into the electronic invoice consortium blockchain, the blockchain node obtains block body information in the new block. The block body information includes information about a plurality of electronic invoices that need to be written into the blockchain.

The blockchain node calculates message hash values corresponding to information about all the electronic invoices in the block body information, and obtains the shared private key. The message hash values and the shared private key are stitched to obtain stitched information, and a hash value of the stitched information is calculated. A digital signature is generated by using the hash value corresponding to the stitched information, the message hash values, and the shared private key.

The digital signature and the information about all the electronic invoices in the block body information are stitched, a hash value of a stitching result is calculated, that is, a hash value of a block that requires writing is obtained, and a hash value of a previous block is obtained from the electronic invoice consortium blockchain, to generate a new block.

A new block consensus request is broadcast, so that each blockchain node in the electronic invoice consortium blockchain obtains the new block according to the new block consensus request, thereby obtaining a pending consensus block.

The blockchain node having the shared private key calculates an information hash value of block body information in the pending consensus block, and obtains the shared private key. The shared private key and the information hash value are stitched, and a hash value of a stitching result is calculated. A digital signature is generated according to the hash value of the stitching result, the information hash value, and the shared private key.

The digital signature and the block body information are stitched, and a hash value of a stitching result is calculated. When the hash value of the stitching result is consistent with the block hash value in the pending consensus block, consensus success information is broadcast. When consensus is complete, the new block is written into the electronic invoice consortium blockchain for storage.

It is to be understood that, although the steps in the flowcharts of FIG. 2 to FIG. 6, FIG. 8, FIG. 10, and FIG. 11 are sequentially displayed according to indication of arrows, the steps are not necessarily sequentially performed in the sequence indicated by the arrows. Unless explicitly specified in this specification, execution of the steps is not strictly limited in the sequence, and the steps may be performed in other sequences. In addition, at least some steps in FIG. 2 to FIG. 6, FIG. 8, FIG. 10, and FIG. 11 may include a plurality of steps or a plurality of stages. The steps or the stages are not necessarily performed at the same moment, and instead may be performed at different moments. The steps or the stages are not necessarily performed sequentially, and instead may be performed in turn or alternately with another step or at least some of steps or stages of the another step.

In an embodiment, as shown in FIG. 12, a digital signature generation apparatus 1200 is provided. The apparatus may be a software module or a hardware module, or a combination thereof as part of a computer device. The apparatus specifically includes a message obtaining module 1202, a calculation module 1204, and a generation module 1206.

The message obtaining module 1202 is configured to obtain a message to be signed, and calculate a message hash value of the message.

The calculation module 1204 is configured to obtain a signature private key, stitch the signature private key and the message hash value to obtain stitched information, and calculate a hash value corresponding to the stitched information.

The generation module 1206 is configured to generate a digital signature corresponding to the message by using the hash value corresponding to the stitched information, the message hash value, and the signature private key.

In an embodiment, the calculation module 1204 includes:

a conversion unit, configured to obtain the signature private key, and convert the signature private key into target information according to a preset conversion rule; and

a stitching unit, configured to stitch the target information and the message hash value to obtain the stitched information.

In an embodiment, the conversion unit is further configured to convert the signature private key into a bit string to obtain a bit string private key; and arrange the bit string private key in reverse order to obtain the target information.

In an embodiment, the conversion unit is further configured to obtain a preset mapping relationship, obtain conversion information corresponding to the signature private key according to the preset mapping relationship, and use the conversion information as the target information.

In an embodiment, the generation module 1206 includes:

a coordinate calculation unit, configured to obtain an elliptic curve base point, and perform calculation by using the hash value corresponding to the stitched information and the elliptic curve base point to obtain elliptic curve point coordinates;

a first signature calculation unit, configured to determine corresponding order information according to the elliptic curve base point, and perform calculation by using the message hash value, the elliptic curve point coordinates, and the order information to obtain a first part digital signature;

a second signature calculation unit, configured to perform calculation by using the first part digital signature, the hash value corresponding to the stitched information, the signature private key, and the order information calculation to obtain a second part digital signature when the first part digital signature meets a preset first condition; and

a signature determining unit, configured to determine the digital signature according to the first part digital signature and the second part digital signature when the second part digital signature meets a preset second condition.

In an embodiment, the digital signature generation apparatus 1200 further includes:

a verification calculation module, configured to obtain a digital signature, and calculate a hash value of the digital signature when the digital signature conforms to a preset signature rule;

a target signature calculation module, configured to obtain a verification public key corresponding to the digital signature, and calculate a target first part digital signature based on the digital signature, the verification public key, and the hash value; and

a verification module, configured to obtain a digital signature verification success result when the target first part digital signature is consistent with a first part digital signature in the digital signature.

In an embodiment, the target signature calculation module is further configured to obtain an elliptic curve base point, determine corresponding order information based on the elliptic curve base point, calculate a target value by using the digital signature and the order information corresponding to the elliptic curve base point, and calculate a to-be-verified elliptic curve point by using a second part digital signature in the digital signature, the elliptic curve base point, the target value, and the verification public key when the target value meets a preset target condition; and calculate the target first part digital signature according to the to-be-verified elliptic curve point, the hash value, and the order information corresponding to the elliptic curve base point.

For a specific limitation on the digital signature generation apparatus, refer to the limitation on the digital signature generation method above. Details are not described herein again. The modules in the foregoing digital signature generation apparatus may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

In an embodiment, as shown in FIG. 13, a blockchain consensus apparatus 1300 is provided. The apparatus may be a software module or a hardware module, or a combination thereof as part of a computer device. The apparatus specifically includes a request receiving module 1302, a stitching module 1304, a digital signature generation module 1306, a hash value calculation module 1308, and a hash value verification module 1310.

The request receiving module 1302 is configured to receive a blockchain consensus request, the blockchain consensus request carrying a pending consensus block, the pending consensus block including block body information and a block hash value.

The stitching module 1304 is configured to calculate an information hash value of the block body information, obtain a shared private key, and stitch the shared private key and the information hash value to obtain a first stitching result.

The digital signature generation module 1306 is configured to calculate a hash value of the first stitching result, and generate a digital signature according to the hash value of the first stitching result, the information hash value, and the shared private key.

The hash value calculation module 1308 is configured to stitch the digital signature and the block body information to obtain a second stitching result, and calculate a hash value of the second stitching result.

The hash value verification module 1310 is configured to broadcast consensus success information when the hash value of the second stitching result is consistent with the block hash value.

In an embodiment, the blockchain consensus apparatus 1300 further includes:

a write module, configured to write the pending consensus block and the digital signature into a blockchain when consensus is complete.

In an embodiment, the blockchain consensus apparatus 1300 further includes:

an instruction receiving module, configured to receive a block write authentication instruction, obtain a written digital signature according to the block write authentication instruction, and calculate a hash value of the written digital signature when the written digital signature conforms to a preset rule;

a verification signature calculation module, configured to obtain a shared public key corresponding to the shared private key, and calculate an authentication first part digital signature according to the shared public key and the hash value; and

a verification module, configured to obtain a block write authentication success result when the authentication first part digital signature is consistent with a first part digital signature in the written digital signature.

In an embodiment, the blockchain consensus apparatus 1300 further includes:

a key sharing module, configured to obtain a key sharing request transmitted by a master node, the key sharing request carrying encrypted shared key information and a master node digital certificate; and

a decryption module, configured to obtain a node private key when the master node digital certificate is successfully verified, and decrypt the encrypted shared key information by using the node private key to obtain shared key information, the shared key information including a shared private key and a corresponding shared public key.

For a specific limitation on the blockchain consensus apparatus, refer to the limitation on the blockchain consensus method above. Details are not described herein again. The modules in the foregoing blockchain consensus apparatus may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules. In this application, the term “unit” or “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

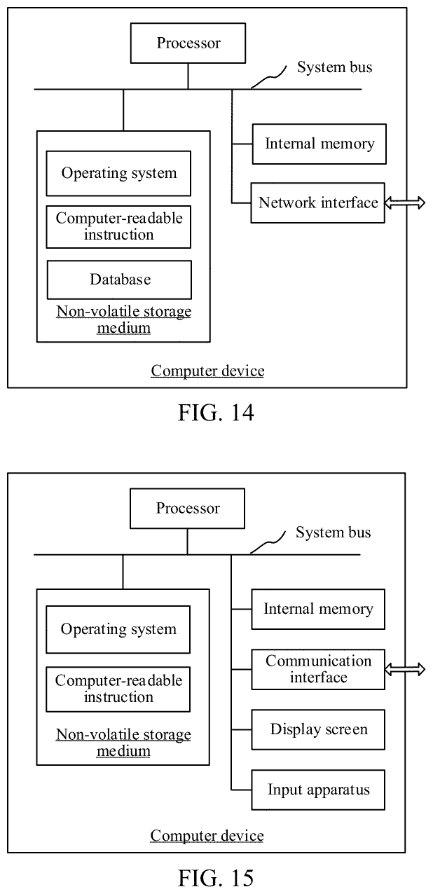

In an embodiment, a computer device is provided. The computer device may be a server, and an internal structure diagram thereof may be shown in FIG. 14. The computer device includes a processor, a memory, and a network interface that are connected by using a system bus. The processor of the computer device is configured to provide computing and control capabilities. The memory of the computer device includes a non-transitory storage medium and an internal memory. The non-transitory storage medium stores an operating system, a computer program, and a database. The internal memory provides an environment for running of the operating system and the computer program in the non-transitory storage medium. The database of the computer device is configured to store a signature private key or store blockchain data. The network interface of the computer device is configured to communicate with an external terminal through a network connection. The computer program is executed by the processor to implement a digital signature generation method or a blockchain consensus method.

In an embodiment, a computer device is provided. The computer device may be a terminal, and an internal structure diagram thereof may be shown in FIG. 15. The computer device includes a processor, a memory, a communication interface, a display screen, and an input apparatus that are connected by using a system bus. The processor of the computer device is configured to provide computing and control capabilities. The memory of the computer device includes a non-transitory storage medium and an internal memory. The non-transitory storage medium stores an operating system and a computer program. The internal memory provides an environment for running of the operating system and the computer program in the non-transitory storage medium. The communications interface of the computer device is configured to communicate with an external terminal in a wired or wireless manner. The wireless manner may be implemented through Wi-Fi, a carrier network, near field communication (NFC), or another technology. The computer program is executed by the processor to implement a digital signature generation method or a blockchain consensus method. The display screen of the computer device may be a liquid crystal display screen or an electronic ink display screen. The input apparatus of the computer device may be a touch layer covering the display screen, or may be a key, a trackball, or a touch pad disposed on a housing of the computer device, or may be an external keyboard, a touch pad, a mouse, or the like.

A person skilled in the art may understand that the structure shown in FIG. 15 or FIG. 14 is only a block diagram of a partial structure related to the solution of this application, and does not limit the computer device to which the solution of this application is applied. Specifically, the computer device may include more or fewer components than those shown in the figure, or some components may be combined, or a different component deployment is used.

In an embodiment, a computer device is provided, including a memory and a processor, the memory storing computer-readable instructions, the processor, when executing the computer-readable instructions, implementing the steps in the foregoing method embodiments.

In an embodiment, one or more non-transitory storage mediums storing computer-readable instructions are provided, the computer-readable instructions, when executed by one or more processors, causing the one or more processors to perform the steps in the foregoing method embodiments.

In an embodiment, a computer program product or a computer program is provided. The computer program product or the computer program includes computer instructions, and the computer instructions are stored in a computer-readable storage medium. The processor of the computer device reads the computer instructions from the computer-readable storage medium, and the processor executes the computer instructions, to cause the computer device to perform the steps in the method embodiments.

A person of ordinary skill in the art may understand that all or some of procedures of the method in the foregoing embodiments may be implemented by a computer program by instructing relevant hardware. The computer program may be stored in a non-transitory computer-readable storage medium. When the computer program is executed, the procedures of the foregoing method embodiments may be implemented. Any reference to a memory, a storage, a database, or another medium used in the embodiments provided in this application may include at least one of a non-transitory memory and a volatile memory. The non-transitory memory may include a read-only memory (ROM), a magnetic tape, a floppy disk, a flash memory, an optical memory, and the like. The volatile memory may include a random access memory (RAM) or an external cache. For the purpose of description instead of limitation, the RAM is available in a plurality of forms, such as a static RAM (SRAM) or a dynamic RAM (DRAM).

The technical features in the above embodiments may be randomly combined. For concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of this application, which are described specifically and in detail, but cannot be construed as a limitation to the patent scope of the present disclosure. For a person of ordinary skill in the art, several transformations and improvements can be made without departing from the idea of this application. These transformations and improvements belong to the protection scope of this application. Therefore, the protection scope of this application is subject to the protection scope of the appended claims.

What is claimed is:

1. A method for generating a digital signature for a message performed by a computer device, the method comprising:
obtaining a message to be signed, and calculating a message hash value of the message;
obtaining a signature private key, stitching the signature private key and the message hash value to obtain stitched information, and calculating a hash value corresponding to the stitched information; and
generating a digital signature corresponding to the message by using the hash value corresponding to the stitched information, the message hash value, and the signature private key, further including:
calculating a first part digital signature by using the hash value corresponding to the stitched information as a random number and the message hash value;
calculating a second part digital signature by using the first part digital signature, the hash value corresponding to the stitched information as the random number, and the signature private key; and
generating the digital signature corresponding to the message by using the first part digital signature and the second part digital signature.

2. The method according to claim 1, wherein the obtaining a signature private key, and stitching the signature private key and the message hash value to obtain stitched information comprises:
obtaining the signature private key, and converting the signature private key into target information according to a preset conversion rule; and
stitching the target information and the message hash value to obtain the stitched information.

3. The method according to claim 2, wherein the converting the signature private key into target information according to a preset conversion rule comprises:
converting the signature private key into a bit string to obtain a bit string private key; and
arranging the bit string private key in reverse order to obtain the target information.

4. The method according to claim 2, wherein the converting the signature private key into target information according to a preset conversion rule comprises:
obtaining a preset mapping relationship, obtaining conversion information corresponding to the signature private key according to the preset mapping relationship, and using the conversion information as the target information.

5. The method according to claim 1, wherein the generating a digital signature corresponding to the message by using the hash value corresponding to the stitched information, the message hash value, and the signature private key comprises:
obtaining an elliptic curve base point, and performing calculation by using the hash value corresponding to the stitched information and the elliptic curve base point to obtain elliptic curve point coordinates;
determining corresponding order information according to the elliptic curve base point, and performing calculation by using the message hash value, the elliptic curve point coordinates, and the order information to obtain the first part digital signature;
performing calculation by using the first part digital signature, the hash value corresponding to the stitched information, the signature private key, and the order information calculation to obtain the second part digital signature when the first part digital signature meets a preset first condition; and
determining the digital signature corresponding to the message according to the first part digital signature and the second part digital signature when the second part digital signature meets a preset second condition.

6. The method according to claim 1, further comprising:
obtaining a digital signature to be verified, and calculating a hash value of the digital signature when the digital signature conforms to a preset signature rule;
obtaining a verification public key corresponding to the digital signature, and calculating a target first part digital signature based on the digital signature, the verification public key, and the hash value; and
obtaining a digital signature verification success result when the target first part digital signature is consistent with a first part digital signature in the digital signature.

7. The method according to claim 6, wherein the obtaining a verification public key corresponding to the digital signature, and calculating a target first part digital signature based on the digital signature, the verification public key, and the hash value comprises:
obtaining an elliptic curve base point, determining corresponding order information based on the elliptic curve base point, calculating a target value by using the digital signature and the order information corresponding to the elliptic curve base point, and calculating a to-be-verified elliptic curve point by using a second part digital signature in the digital signature, the elliptic curve base point, the target value, and the verification public key when the target value meets a preset target condition; and
calculating the target first part digital signature according to the to-be-verified elliptic curve point, the hash value, and the order information corresponding to the elliptic curve base point.

8. A computer device, comprising a memory and a processor, the memory storing computer-readable instructions, the computer-readable instructions, when executed by the processor, causing the computer device to perform a method for generating a digital signature for a message including:
obtaining a message to be signed, and calculating a message hash value of the message;
obtaining a signature private key, stitching the signature private key and the message hash value to obtain stitched information, and calculating a hash value corresponding to the stitched information; and
generating a digital signature corresponding to the message by using the hash value corresponding to the stitched information, the message hash value, and the signature private key, further including:
calculating a first part digital signature by using the hash value corresponding to the stitched information as a random number and the message hash value;
calculating a second part digital signature by using the first part digital signature, the hash value corresponding to the stitched information as the random number, and the signature private key; and
generating the digital signature corresponding to the message by using the first part digital signature and the second part digital signature.

9. The computer device according to claim 8, wherein the obtaining a signature private key, and stitching the signature private key and the message hash value to obtain stitched information comprises:
obtaining the signature private key, and converting the signature private key into target information according to a preset conversion rule; and
stitching the target information and the message hash value to obtain the stitched information.

10. The computer device according to claim 9, wherein the converting the signature private key into target information according to a preset conversion rule comprises:
converting the signature private key into a bit string to obtain a bit string private key; and
arranging the bit string private key in reverse order to obtain the target information.

11. The computer device according to claim 9, wherein the converting the signature private key into target information according to a preset conversion rule comprises:
obtaining a preset mapping relationship, obtaining conversion information corresponding to the signature private key according to the preset mapping relationship, and using the conversion information as the target information.

12. The computer device according to claim 9, wherein the generating a digital signature corresponding to the message by using the hash value corresponding to the stitched information, the message hash value, and the signature private key comprises:
obtaining an elliptic curve base point, and performing calculation by using the hash value corresponding to the stitched information and the elliptic curve base point to obtain elliptic curve point coordinates;
determining corresponding order information according to the elliptic curve base point, and performing calculation by using the message hash value, the elliptic curve point coordinates, and the order information to obtain the first part digital signature;
performing calculation by using the first part digital signature, the hash value corresponding to the stitched information, the signature private key, and the order information calculation to obtain the second part digital signature when the first part digital signature meets a preset first condition; and
determining the digital signature corresponding to the message according to the first part digital signature and the second part digital signature when the second part digital signature meets a preset second condition.

13. The computer device according to claim 8, wherein the method further comprises:
obtaining a digital signature to be verified, and calculating a hash value of the digital signature when the digital signature conforms to a preset signature rule;
obtaining a verification public key corresponding to the digital signature, and calculating a target first part digital signature based on the digital signature, the verification public key, and the hash value; and
obtaining a digital signature verification success result when the target first part digital signature is consistent with a first part digital signature in the digital signature.

14. The computer device according to claim 13, wherein the obtaining a verification public key corresponding to the digital signature, and calculating a target first part digital signature based on the digital signature, the verification public key, and the hash value comprises:
obtaining an elliptic curve base point, determining corresponding order information based on the elliptic curve base point, calculating a target value by using the digital signature and the order information corresponding to the elliptic curve base point, and calculating a to-be-verified elliptic curve point by using a second part digital signature in the digital signature, the elliptic curve base point, the target value, and the verification public key when the target value meets a preset target condition; and
calculating the target first part digital signature according to the to-be-verified elliptic curve point, the hash value, and the order information corresponding to the elliptic curve base point.

15. One or more non-transitory storage mediums storing computer-readable instructions, the computer-readable instructions, when executed by one or more processors of a computer device, causing the computer device to perform a method for generating a digital signature for a message including:
obtaining a message to be signed, and calculating a message hash value of the message;
obtaining a signature private key, stitching the signature private key and the message hash value to obtain stitched information, and calculating a hash value corresponding to the stitched information; and
generating a digital signature corresponding to the message by using the hash value corresponding to the stitched information, the message hash value, and the signature private key, further including:
calculating a first part digital signature by using the hash value corresponding to the stitched information as a random number and the message hash value;
calculating a second part digital signature by using the first part digital signature, the hash value corresponding to the stitched information as the random number, and the signature private key; and
generating the digital signature corresponding to the message by using the first part digital signature and the second part digital signature.

16. The non-transitory storage mediums according to claim 15, wherein the obtaining a signature private key, and stitching the signature private key and the message hash value to obtain stitched information comprises:
obtaining the signature private key, and converting the signature private key into target information according to a preset conversion rule; and
stitching the target information and the message hash value to obtain the stitched information.

17. The non-transitory storage mediums according to claim 16, wherein the converting the signature private key into target information according to a preset conversion rule comprises:
converting the signature private key into a bit string to obtain a bit string private key; and
arranging the bit string private key in reverse order to obtain the target information.

18. The non-transitory storage mediums according to claim 16, wherein the converting the signature private key into target information according to a preset conversion rule comprises:
obtaining a preset mapping relationship, obtaining conversion information corresponding to the signature private key according to the preset mapping relationship, and using the conversion information as the target information.

19. The non-transitory storage mediums according to claim 16, wherein the generating a digital signature corresponding to the message by using the hash value corresponding to the stitched information, the message hash value, and the signature private key comprises:
obtaining an elliptic curve base point, and performing calculation by using the hash value corresponding to the stitched information and the elliptic curve base point to obtain elliptic curve point coordinates;
determining corresponding order information according to the elliptic curve base point, and performing calculation by using the message hash value, the elliptic curve point coordinates, and the order information to obtain the first part digital signature;
performing calculation by using the first part digital signature, the hash value corresponding to the stitched information, the signature private key, and the order information calculation to obtain the second part digital signature when the first part digital signature meets a preset first condition; and
determining the digital signature corresponding to the message according to the first part digital signature and the second part digital signature when the second part digital signature meets a preset second condition.

20. The non-transitory storage mediums according to claim 15, wherein the method further comprises:
obtaining a digital signature to be verified, and calculating a hash value of the digital signature when the digital signature conforms to a preset signature rule;
obtaining a verification public key corresponding to the digital signature, and calculating a target first part digital signature based on the digital signature, the verification public key, and the hash value; and
obtaining a digital signature verification success result when the target first part digital signature is consistent with a first part digital signature in the digital signature.
